(19) United States
(12) Patent Application Publication
(10) Pub. No.: US 2026/0312005 A1
(43) Pub. Date: Oct. 8, 2026

(54) NEGATIVE ELECTRODE FOR NON-AQUEOUS ELECTROLYTE SECONDARY BATTERY

(71) Applicant: TOYOTA JIDOSHA KABUSHIKI KAISHA, Toyota-shi (JP)

(72) Inventor: Daiki MAEDA, Toyota-shi (JP)

(73) Assignee: TOYOTA JIDOSHA KABUSHIKI KAISHA, Toyota-shi (JP)

(21) Appl. No.: 19/539,425

(22) Filed: Feb. 13, 2026

(30) Foreign Application Priority Data
Apr. 3, 2025 (JP) 2025-062011

(51) Int. Cl. H01M 4/36; H01M 4/587; H01M 4/02

(52) U.S. Cl. CPC H01M 4/364; H01M 4/587; H01M 2004/027

(57) ABSTRACT

A negative electrode for a non-aqueous electrolyte secondary battery includes a collector, a first active material layer, and a second active material layer in this order. The first active material layer and the second active material layer each contain a negative electrode active material. The negative electrode active material contains artificial graphite and natural graphite. A mass fraction of the artificial graphite in the first active material layer is higher than that in the second active material layer. A mass fraction of the natural graphite in the first active material layer is lower than that in the second active material layer. An alignment angle of the negative electrode active material in the second active material layer is larger than that in the first active material layer. The alignment angle indicates an acute angle between a major axis diameter of the negative electrode active material and a surface of the collector.

### CROSS-REFERENCE TO RELATED APPLICATION

This application claims priority to Japanese Patent Application No. 2025-062011 filed on Apr. 3, 2025. The disclosure of the above-identified application, including the specification, drawings, and claims, is incorporated by reference herein in its entirety.

### BACKGROUND

### 1. Technical Field

The present disclosure relates to a negative electrode for a non-aqueous electrolyte secondary battery.

### 2. Description of Related Art

Japanese Unexamined Patent Application Publication No. 2009-064574 (JP 2009-064574 A) discloses a multilayer structure in which a first negative electrode layer on a side close to a negative electrode collector has artificial graphite and a second negative electrode layer on a side far from the negative electrode collector has natural graphite.

### SUMMARY

Hereinafter, the “negative electrode for a non-aqueous electrolyte secondary battery” may be abbreviated as “negative electrode”. A negative electrode having a multilayer structure is proposed. For example, a proposal is made to dispose artificial graphite in a lower layer on a side close to the negative electrode collector and to dispose natural graphite in an upper layer on a side far from the negative electrode collector. By disposing the natural graphite having relatively favorable charge rate characteristics on a side close to a positive electrode, improvement in charge rate characteristics is expected. However, there is still room for the improvement in the charge rate characteristics.

An object of the present disclosure is to improve charge rate characteristics.

Hereinafter, technical configurations and effects of the present disclosure will be described. However, an action mechanism includes an estimation. The action mechanism does not limit the technical scope of the present disclosure.

1. A negative electrode for a non-aqueous electrolyte secondary battery according to one aspect of the present disclosure includes a collector, a first active material layer, and a second active material layer in this order. Each of the first active material layer and the second active material layer contains a negative electrode active material. The negative electrode active material contains artificial graphite and natural graphite. A mass fraction of the artificial graphite in the first active material layer is higher than a mass fraction of the artificial graphite in the second active material layer. A mass fraction of the natural graphite in the first active material layer is lower than a mass fraction of the natural graphite in the second active material layer. An alignment angle of the negative electrode active material in the second active material layer is larger than an alignment angle of the negative electrode active material in the first active material layer. The alignment angle indicates an acute angle between a major axis diameter of the negative electrode active material and a surface of the collector.

With new findings of the present disclosure, the improvement in the charge rate characteristics is expected by achieving a balance between Li ion receptivity, electron conductivity, and curvature in a thickness direction of the active material layer. The “curvature” in the present disclosure indicates a tortuosity of fine pores in the thickness direction of the active material layer. The smaller the curvature, the more the fine pores are evaluated to linearly extend in the thickness direction. A consideration is made that, by the curvature being small, diffusion of an electrolytic solution in the thickness direction of the active material layer can be promoted.

FIG. 1 is a conceptual sectional view showing a first multilayer structure in the present embodiment. In the drawings of the present disclosure, “NG” indicates natural graphite. “AG” indicates artificial graphite. A circular element indicates an unaligned active material. An elliptical element indicates an active material aligned in the thickness direction. The degree of alignment is evaluated by an alignment angle. As the alignment angle is larger, the particles are considered to be more strongly aligned in the thickness direction. The negative electrode 20 includes a collector 21, a first active material layer 22a (lower layer), and a second active material layer 22b (upper layer) in this order. For example, a consideration is made to dispose artificial graphite “AG” in the first active material layer 22a and to dispose natural graphite “NG” in the second active material layer 22b. The natural graphite tends to have higher Li ion receptivity than the artificial graphite. By disposing the natural graphite in the upper layer, improvement in the charge rate characteristics is expected. However, in the first multilayer structure, since the balance between the Li ion receptivity, the electron conductivity, and the curvature is not achieved, the desired charge rate characteristics may not be obtained.

FIG. 2 is a conceptual sectional view showing a second multilayer structure in the present embodiment. As a method of reducing the curvature, a consideration is made to align the negative electrode active material in the thickness direction of the negative electrode. In the second multilayer structure, the negative electrode active material is aligned in the thickness direction in both the upper layer and the lower layer. In the second multilayer structure, the curvature may be excessively small in the entire thickness direction. In addition, electron conduction between the collector 21 and the lower layer and electron conduction in the lower layer may be insufficient. Also in the second multilayer structure, since the balance between the Li ion receptivity, the electron conductivity, and the curvature is not achieved, the desired charge rate characteristics may not be obtained.

FIG. 3 is a conceptual sectional view showing a third multilayer structure in the present embodiment. In the third multilayer structure, the negative electrode active material (artificial graphite) of the lower layer is aligned in the thickness direction. The electrolytic solution permeates from the surface of the negative electrode 20 toward the inside. Since the curvature of the upper layer is high, the electrolytic solution may have difficulty passing through the upper layer. Since supply of the electrolytic solution to the lower layer is insufficient, reception of Li ions in the lower layer may be inactive. Also in the third multilayer structure, since the balance between the Li ion receptivity, the electron conductivity, and the curvature is not achieved, the desired charge rate characteristics may not be obtained.

FIG. 4 is a conceptual sectional view showing a fourth multilayer structure in the present embodiment. In the fourth multilayer structure, the negative electrode active material (natural graphite) of the upper layer is aligned in the thickness direction. The natural graphite relatively strongly aligned in the upper layer is expected to further promote the reception of the Li ions and promote the supply of the electrolytic solution to the lower layer.

The artificial graphite relatively weakly aligned in the lower layer is expected to promote electron conduction and ion conduction in an in-plane direction. As a result, in the entire negative electrode 20, since the balance between the Li ion receptivity, the electron conductivity, and the curvature is improved, further improvement in the charge rate characteristics is expected.

2. The negative electrode according to the “1” may include, for example, the following configuration. Each of the first active material layer and the second active material layer further contains a binder. A mass fraction of the binder in the first active material layer is lower than a mass fraction of the binder in the second active material layer.

In a manufacturing process of the negative electrode, the negative electrode may be subjected to roll pressing. By the roll pressing, the negative electrode active material on the surface of the negative electrode may be tilted laterally, and the alignment angle may be reduced. Since the mass fraction of the binder in the second active material layer is relatively high, the negative electrode active material is expected to be less likely to be tilted.

3. The negative electrode according to the “1” or the “2” may include, for example, the following configuration. The negative electrode for a non-aqueous electrolyte secondary battery includes the collector, the first active material layer, a binder layer, and the second active material layer in this order. A mass fraction of the binder in the binder layer is higher than the mass fractions of the binder in the first active material layer and the second active material layer.

The negative electrode active material expands during charging and contracts during discharging. Since the alignment of the negative electrode active material is different between the upper layer and the lower layer, a mismatch in an expansion direction and a contraction direction of the negative electrode active material may occur at an interface between the upper layer and the lower layer. The mismatch in the volume change may cause interlayer peeling. The binder layer is expected to absorb the mismatch in the volume change and increase an adhesiveness between the upper layer and the lower layer. The interlayer peeling is expected to be reduced by the binder layer.

4. The negative electrode according to any one of the “1” to the “3” may include, for example, the following configuration. The negative electrode active material in the first active material layer has a bimodal particle size distribution. The negative electrode active material in the second active material layer has a monomodal particle size distribution.

Since the negative electrode active material of the lower layer is a bimodal type, the particles can be densely filled, and thus, for example, the adhesion strength to the collector is expected to be improved. Since the negative electrode active material of the upper layer is a monomodal type, the fine pores along the thickness direction are expected to be easily formed in a case where the negative electrode active material is aligned in the thickness direction.

5. A negative electrode for a non-aqueous electrolyte secondary battery according to one aspect of the present disclosure includes a collector, a first active material layer, a binder layer, and a second active material layer in this order. Each of the first active material layer and the second active material layer contains a negative electrode active material and a binder. The negative electrode active material in the first active material layer has a bimodal particle size distribution. The negative electrode active material in the second active material layer has a monomodal particle size distribution. A mass fraction of the binder in the first active material layer is lower than a mass fraction of the binder in the second active material layer. The negative electrode active material contains artificial graphite and natural graphite. The natural graphite has a larger aspect ratio than the artificial graphite. The negative electrode active material in the first active material layer substantially consists of the artificial graphite. The negative electrode active material in the second active material layer substantially consists of the natural graphite. An alignment angle of the negative electrode active material in the second active material layer is larger than an alignment angle of the negative electrode active material in the first active material layer. The alignment angle indicates an acute angle between a major axis diameter of the negative electrode active material and a surface of the collector. A mass fraction of the binder in the binder layer is higher than the mass fractions of the binder in the first active material layer and the second active material layer.

Hereinafter, an embodiment of the present disclosure (hereinafter, may be abbreviated as “the present embodiment”) will be described. Here, the present embodiment does not limit the technical scope of the present disclosure. The present embodiment is exemplary in all aspects. The present embodiment is not restrictive. The technical scope of the present disclosure includes all changes within the meaning and the scope that are equivalent to the description of CLAIMS. For example, extracting arbitrary configurations from the present embodiment and arbitrarily combining the configurations are preconceived from the first.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual sectional view showing a first multilayer structure in the present embodiment;

FIG. 2 is a conceptual sectional view showing a second multilayer structure in the present embodiment;

FIG. 3 is a conceptual sectional view showing a third multilayer structure in the present embodiment;

FIG. 4 is a conceptual sectional view showing a fourth multilayer structure in the present embodiment;

FIG. 5 is a conceptual sectional view for describing an alignment angle in the present embodiment;

FIG. 6 is a conceptual diagram showing an example of a non-aqueous electrolyte secondary battery in the present embodiment;

FIG. 7 is a graph showing an example of a first particle size distribution in the present embodiment; and

FIG. 8 is a graph showing an example of a second particle size distribution in the present embodiment.

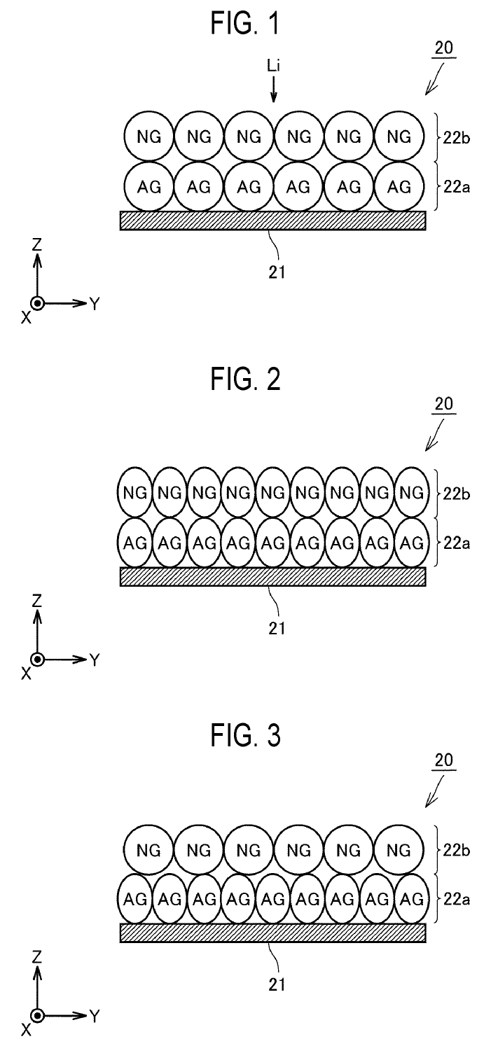

### DETAILED DESCRIPTION OF EMBODIMENTS

### Terms and Phrases

The terms “comprising”, “including”, “having”, and modifications thereof are open-ended expressions. A configuration expressed in an open-ended manner may further include or may not include an additional element in addition to the essential element. The description of “consisting of” is a closed-ended expression. However, even in a configuration expressed in a closed-ended manner, an additional element that is usually an

impurity or is irrelevant to the target technology may be included. The description of “substantially consisting of” is a semi-closed-ended expression. In a configuration expressed in a semi-closed-ended manner, addition of an element that does not substantially affect the basic and novel characteristics of the target technology is allowed.

Geometric terms should not be construed in a strict sense. Examples of the geometric terms include “parallel”, “perpendicular”, and “orthogonal”. For example, a direction, an angle, a distance, or the like may be relatively displaced within a range in which substantially the same or similar functions are obtained. The geometric terms may include a tolerance, an error, or the like in design, operation, manufacturing, or the like. The dimensional relationships in each of the drawings may not match the actual dimensional relationships. For the understanding of the reader, the dimensional relationships in each of the drawings may be changed. For example, a length, a width, and a thickness may be changed. Some configurations may be omitted.

The “artificial graphite” indicates graphite synthesized by artificial heat treatment. The artificial graphite is also referred to as synthetic graphite (SG). The “natural graphite” indicates graphite generated in nature. The natural graphite includes flake graphite. The flake graphite may be rounded such that an end of the particle is bent.

The “particle diameter” is specified by a microscope method. The particle diameter indicates an arithmetic average of a long side and a short side in a minimum bounding rectangle (MBR) of a two-dimensional image of the particle. The “average particle diameter” indicates an arithmetic average of particle diameters of 100 particles randomly extracted. Various image analyses in the present embodiment may be performed by software. For example, “ImageJ” may be used.

The “aspect ratio” indicates a ratio of the long side to the short side of the MBR. An arithmetic average of aspect ratios of 100 particles randomly extracted is adopted.

FIG. 5 is a conceptual sectional view for describing an alignment angle in the present embodiment. The “alignment angle” is an acute angle “θ” between the major axis diameter “L” of the particle and the surface of the collector 21 in a cross-sectional scanning electron microscope (SEM) image of the negative electrode 20. The alignment angle can take a value of 0° to 90°. The major axis diameter indicates a maximum Feret diameter of the particle. An arithmetic average of alignment angles of 100 particles randomly extracted is adopted.

The “basis weight” indicates a mass per unit area.

The “void ratio” is specified by an image analysis method. The void and the solid are discriminated by binarizing the cross-sectional SEM image of each layer. The void ratio is obtained by dividing the total area (total pixels) of the voids by the area of the entire layer.

The “active material layer” is a general term for the first active material layer and the second active material layer.

### Non-Aqueous Electrolyte Secondary Battery

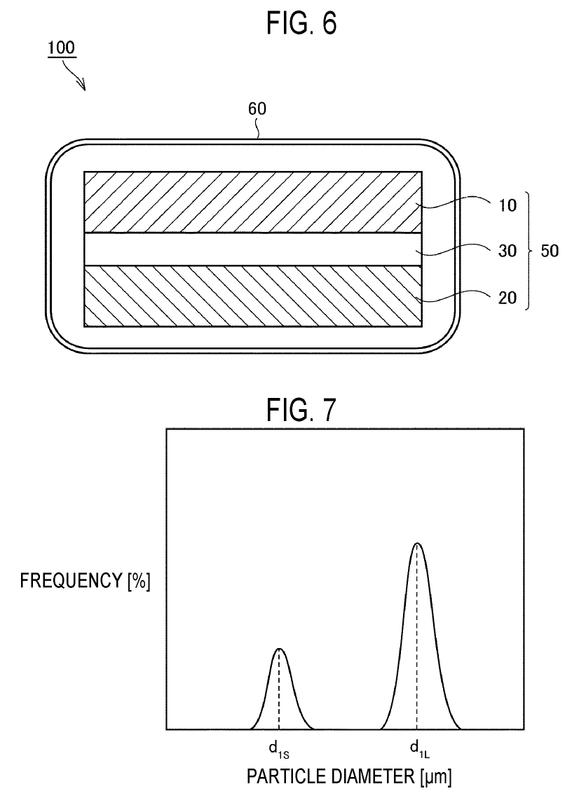

FIG. 6 is a conceptual diagram showing an example of a non-aqueous electrolyte secondary battery in the present embodiment. The non-aqueous electrolyte secondary battery 100 may include, for example, a power generation element 50 and a case 60. The case 60 accommodates the power generation element 50. The case 60 may be, for example, a container made of metal or a pouch made of an aluminum laminate film. The power generation element 50 may include, for example, a positive electrode 10, a negative electrode 20, a separator 30, and a non-aqueous electrolyte (not shown). The power generation element 50 may be, for example, a wound type or a laminated type. The power generation element 50 may have a monopolar structure or a bipolar structure. The separator 30 can electrically separate the positive electrode 10 from the negative electrode 20. The separator 30 may include, for example, a porous film made of a resin. The non-aqueous electrolyte is an Li ion conductor. The non-aqueous electrolyte may include, for example, an Li salt and an organic solvent. The non-aqueous electrolyte may be, for example, impregnated in the separator 30. The non-aqueous electrolyte may include, for example, a polymer electrolyte, a gel electrolyte, and a solid electrolyte. The solid electrolyte may include, for example, a sulfide solid electrolyte, an oxide solid electrolyte, and a halide solid electrolyte. The positive electrode 10 contains a positive electrode active material. The positive electrode active material may include, for example, a lithium transition metal composite oxide (Li[NiCoMn]O₂) or a lithium phosphate compound (Li[FeMn]PO₄). The description of [NiCoMn], [FeMn], and the like indicates that the total of the compositional ratios of the components in [] is “1”. The compositional ratio of each component is optional as long as the total is 1. For example, the compositional ratio of some components may be zero.

### Negative Electrode

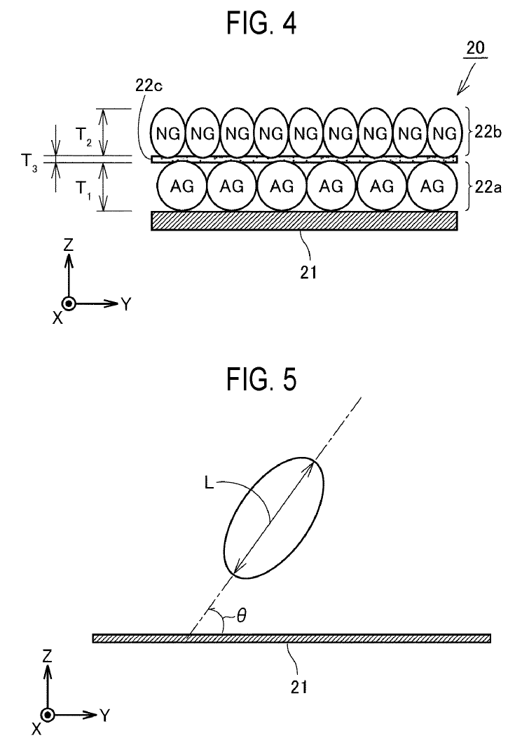

The negative electrode 20 may have a sheet-like shape, for example. The negative electrode 20 has a fourth laminated structure (FIG. 4). The negative electrode 20 includes the collector 21, the first active material layer 22a, and the second active material layer 22b in this order in the thickness direction. The active material layer may be disposed on a part of the surface of the collector 21 or may be disposed on the entire surface. The active material layer may be disposed on only one surface of the collector 21 or may be disposed on both surfaces of the collector 21. The collector 21 may include, for example, a metal foil (a Cu foil, a Ni foil, or the like) or a conductive resin layer. The collector 21 may have a thickness of, for example, 1 μm to 100 μm.

The negative electrode 20 may further include any element as long as the collector 21, the first active material layer 22a, and the second active material layer 22b are included in this order. For example, the negative electrode 20 may include the collector 21, the first active material layer 22a, the binder layer 22c, and the second active material layer 22b in this order. For example, a conductive layer, an adhesion layer (both not shown), or the like may be disposed between the first active material layer 22a and the collector 21. For example, a ceramic particle layer or the like (not shown) may be disposed on the surface of the second active material layer 22b. The ceramic particle layer may include, for example, a heat-resistant ceramic (alumina, boehmite).

Each layer included in the negative electrode active material layer 22 may be, for example, a coating layer. The coating layer indicates a layer formed by applying a coating material. Each coating material may be applied substantially simultaneously or may be applied sequentially. For example, before the coating material is dried, the negative electrode active material included in the coating layer can be aligned in the thickness direction by applying a magnetic field to the coating layer. For example, the alignment angle may be adjusted by the strength of the magnetic field, the concentration of the coating material, the pressing pressure, and the like.

Each layer may have any thickness. For example, a thickness “T₁” of the first active material layer 22a and a thickness “T₂” of the second active material layer 22b may satisfy a relationship of “T₁/T₂ = 1/9 to 9/1”, “T₁/T₂= 2/8 to 8/2”, “T₁/T₂ = 3/7 to 7/3”, or “T₁/T₂= 4/6 to 6/4”. The thickness “T₁” may be, for example, 10 μm or more, 50 μm or more, 100 μm or more, 200 μm or more, or 500 μm or more. The thickness “T₁” may be, for example, 1 mm or less, 500 μm or less, or 200 μm or less.

Each layer may have any basis weight. For example, a basis weight “W₁” of the first active material layer 22a and a basis weight “W₂” of the second active material layer 22b may satisfy a relationship of “W₁/W₂ = 1/9 to 9/1”, “W₁/W₂ = 2/8 to 8/2”, “W₁/W₂ = 3/7 to 7/3”, or “W₁/W₂ = 4/6 to 6/4”. The basis weight “W₁” may be, for example, 1 mg/cm² or more, 5 mg/cm² or more, 10 mg/cm² or more, or 20 mg/cm² or more. The basis weight “W₁” may be, for example, 50 mg/cm² or less, 30 mg/cm² or less, 25 mg/cm² or less, 15 mg/cm² or less, or 10 mg/cm² or less.

The void ratio of the active material layer may be substantially constant over the entire region. The void ratio of the active material layer may be locally different. For example, the void ratio “φ₁” of the first active material layer 22a may be lower than the void ratio “φ₂” of the second active material layer 22b. That is, a relationship of “φ₁ < φ₂” or “1 < φ₂/φ₁” may be satisfied. The ratio “φ₂/φ₁” may be, for example, 1.2 or more, 1.5 or more, 2 or more, or 2.5 or more. The ratio “φ₂/φ₁” may be, for example, 5 or less, 3 or less, or 2 or less.

### Negative Electrode Active Material

Each of the first active material layer 22a and the second active material layer 22b contains the negative electrode active material. Each of the active material layers may further contain, for example, a conductive material and a binder. The active material layers may each independently contain, for example, in terms of mass fraction, 0% to 10% of a binder, 0% to 10% of a conductive material, and a negative electrode active material as a remainder. The mass fractions of the binder and the conductive material in each of the active material layers may be each independently 0.1% to 3% or 0.5% to 2%.

The negative electrode active material contains artificial graphite and natural graphite. The negative electrode active material may further include other active materials in addition to the artificial graphite and the natural graphite. The other active materials may include, for example, Si, SiO, lithium titanate, a Sn-based alloy, SnO, pure Li, an Li-based alloy, and the like.

The artificial graphite is unevenly distributed in the first active material layer 22a. A mass fraction “M_{1A}” of the artificial graphite in the first active material layer 22a is higher than a mass fraction “M_{2A}” of the artificial graphite in the second active material layer 22b. That is, a relationship of “M_{2A} < M_{1A}” or “1 < M_{1A}/M_{2A}” is satisfied. The ratio “M_{1A}/M_{2A}” may be, for example, 1.5 or more, 2 or more, 3 or more, 5 or more, 10 or more, 50 or more, or 100 or more. The ratio “M_{1A}/M_{2A}” may be, for example, 1000 or less or 100 or less. The mass fraction “M_{1A}” may be, for example, 40% or more, 50% or more, 60% or more, 70% or more, 80% or more, 90% or more, 95% or more, 98% or more, or 99% or more. The mass fraction “M_{1A}” may be, for example, 100% or less, 99% or less, 98% or less, or 95% or less.

The natural graphite is unevenly distributed in the second active material layer 22b. A mass fraction “M_{1N}” of the natural graphite in the first active material layer 22a is lower than a mass fraction “M_{2N}” of the natural graphite in the second active material layer 22b. That is, a relationship of “M_{1N} < M_{2N}” or “M_{1N}/M_{2N} < 1” is satisfied. The ratio “M_{1N}/M_{2N}” may be, for example, 0.9 or less, 0.5 or less, 0.3 or less, 0.1 or less, or 0.01 or less. The ratio “M_{1N}/M_{2N}” may be, for example, 0 or more, 0.001 or more, 0.01 or more, or 0.1 or more. The mass fraction “M_{2N}” may be, for example, 40% or more, 50% or more, 60% or more, 70% or more, 80% or more, 90% or more, 95% or more, 98% or more, or 99% or more. The mass fraction “M_{2N}” may be, for example, 100% or less, 99% or less, 98% or less, or 95% or less.

As described above, the first active material layer 22a and the second active material layer 22b can each independently contain the artificial graphite, the natural graphite, and the other active materials as long as the relationship of “M_{2A} < M_{1A}” and “M_{1N} < M_{2N}” is satisfied. For example, the negative electrode active material in the first active material layer 22a may substantially consist of the artificial graphite and the Si-based active material. The negative electrode active material in the second active material layer 22b may substantially consist of the natural graphite.

The artificial graphite and the natural graphite may each independently have any particle shape. The particle shape may be, for example, spherical, ellipsoidal, or flat. For example, an aspect ratio “R_{N}” of the natural graphite may be larger than an aspect ratio “R_{A}” of the artificial graphite. For example, a relationship of “1 < R_{N}/R_{A} ≤ 5” may be satisfied. The aspect ratio “R_{N}” of the natural graphite may be, for example, 1.5 or more, 2 or more, or 3 or more. The aspect ratio “R_{N}” of the natural graphite may be, for example, 5 or less. The aspect ratio “R_{A}” of the artificial graphite may be, for example, less than 1.5, 1.4 or less, 1.3 or less, 1.2 or less, or 1.1 or less. The aspect ratio “R_{A}” of the artificial graphite may be, for example, 1 or more.

The alignment properties of the negative electrode active material are different between the first active material layer 22a and the second active material layer 22b. An alignment angle “θ₂” of the negative electrode active material in the second active material layer 22b is larger than an alignment angle “θ₁” of the negative electrode active material in the first active material layer 22a. That is, a relationship of “θ₁ < θ₂” is satisfied. The alignment angle “θ₂” may be, for example, 30° or more, 45° or more, 60° or more, or 75° or more. The alignment angle “θ₂” may be, for example, 90° or less, 75° or less, or 60° or less. The alignment angle “θ₁” may be, for example, less than 30°, 15° or less, or 5° or less. The alignment angle “θ₁” may be, for example, 0° or more.

The artificial graphite and the natural graphite may each independently have any average particle diameter. The average particle diameter may be, for example, 1 μm or more, 5 μm or more, 10 μm or more, or 15 μm or more. The average particle diameter may be, for example, 30 μm or less, 20 μm or less, 15 μm or less, or 10 μm or less.

The particle size distributions may be different between the first active material layer 22a and the second active material layer 22b. The particle size distribution may be based on volume or may be based on the number of particles. In the present embodiment, in the histogram, a convex region having a height of 0.1 times or more the height of the maximum peak is regarded as a peak. The number of peaks may be, for example, 1 or more, 2 or more, or 3 or more. The “monomodal type (also referred to as a unimodal type)” indicates a distribution in which there is substantially one peak. The “bimodal type” indicates a distribution in which there are substantially two peaks. The “multimodal type” indicates a distribution in which there are three or more peaks.

FIG. 7 is a graph showing an example of a first particle size distribution in the present embodiment. The negative electrode active material in the first active material layer 22a may have the first particle size distribution. The first particle size distribution is a bimodal type. The peak on the side with a large particle diameter has a mode diameter “d_{1L}”. The “mode diameter (most frequent value)” indicates a particle diameter corresponding to the peak top. The mode diameter “d_{1L}” may be regarded as an average particle diameter of a large particle group. The peak on the side with a small particle diameter has a mode diameter “d_{1S}”. The mode diameter “d_{1S}” may be regarded as an average particle diameter of a small particle group. A size ratio “d_{1L}/d_{1S}” may be, for example, 2 or more, 3 or more, 4 or more, or 5 or more. The size ratio “d_{1L}/d_{1S}” may be, for example, 10 or less, 8 or less, or 6 or less.

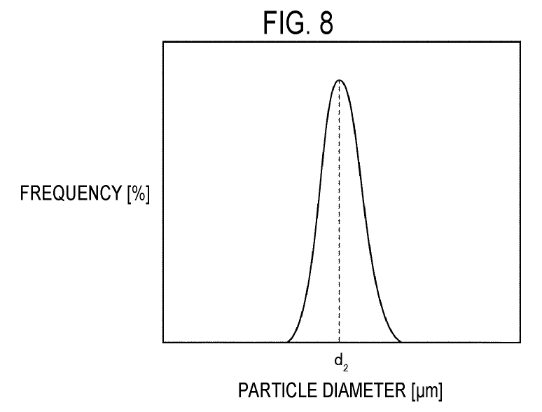

FIG. 8 is a graph showing an example of a second particle size distribution in the present embodiment. The negative electrode active material in the second active material layer 22b may have the second particle size distribution. The second particle size distribution is a monomodal type. The peak has a mode diameter “d₂”. The mode diameter “d₂” may be regarded as an average particle diameter of the negative electrode active material in the second active material layer 22b.

For example, a relationship of “d_{1S} < d₂ < d_{1L}”, “d_{1S} < d_{1L} < d₂”, or “d₂ < d_{1S} < d_{1L}” may be satisfied between the first particle size distribution (FIG. 7) and the second particle size distribution (FIG. 8). By satisfying the relationships, for example, improvement in the balance between the Li ion receptivity, the electron conductivity, and the curvature is expected.

### Binder

The binder may include, for example, styrene butadiene rubber (SBR), carboxymethyl cellulose (CMC), polyacrylic acid (PAA), or polytetrafluoroethylene (PTFE). The mass fraction of the binder may be substantially constant over the entire region of the active material layer. The mass fraction of the binder may be locally different. For example, the mass fraction of the binder may be different between the first active material layer 22a and the second active material layer 22b. For example, a mass fraction “M_{1B}” of the binder in the first active material layer 22a may be lower than a mass fraction “M_{2B}” of the binder in the second active material layer 22b. That is, a relationship of “M_{1B} < M_{2B}” or “1 < M_{2B}/M_{1B}” may be satisfied. The ratio “M_{2B}/M_{1B}” may be, for example, 1.2 or more, 1.5 or more, 2 or more, or 2.5 or more. The ratio “M_{2B}/M_{1B}” may be, for example, 3 or less or 2 or less.

For example, a binder layer 22c may be provided between the first active material layer 22a and the second active material layer 22b. A mass fraction of the binder in the binder layer 22c is higher than a mass fraction of the binder in the first active material layer 22a and the second active material layer 22b. The binder layer 22c may be a layer that substantially does not contain a negative electrode active material. The binder layer 22c may contain, for example, in terms of mass fraction, 0% to 10% of a conductive material, and a binder as a remainder. A mass fraction of the conductive material in the binder layer 22c may be, for example, 1% to 5%.

For example, the type of the binder may be the same between the layers. For example, the type of the binder may be different between the layers. For example, the binder in the binder layer 22c may include a resin that swells with an electrolytic solution. For example, the binder in the binder layer 22c may include a resin having ion permeability or a resin having ion conductivity. The improvement in the charge rate characteristics is expected by allowing the electrolytic solution and the Li ions to permeate the binder layer 22c. For example, the binder in the binder layer 22c may include a fibrous resin. The fibrous resin may extend to crosslink the first active material layer 22a and the second active material layer 22b. By crosslinking the first active material layer 22a and the second active material layer 22b with the fibrous resin, for example, the improvement in the peel strength is expected. The binder in the binder layer 22c may contain, for example, at least one selected from the group consisting of PAA, polyacrylic acid ester, CMC, alginic acid, polyvinylidene fluoride (PVDF), poly(vinylidene fluoride-co-hexafluoropropylene) (PVDF-HFP), and PTFE. For example, PAA, PVDF, PVDF-HFP, and the like may have swellability, ion permeability, or ion conductivity. For example, PTFE may be fibrous.

A thickness “T₃” of the binder layer 22c may be, for example, smaller than the thickness “T₁” of the first active material layer 22a and the thickness “T₂” of the second active material layer 22b. The thickness “T₃” of the binder layer 22c may be, for example, 10 μm or less, 5 μm or less, or 3 μm or less. The thickness “T₃” of the binder layer 22c may be, for example, 0.5 μm or more, 1 μm or more, or 3 μm or more. A basis weight “W₃” of the binder layer 22c may be, for example, smaller than the basis weight “W₁” of the first active material layer 22a and the basis weight “W₂” of the second active material layer 22b. The basis weight “W₃” of the binder layer 22c may be, for example, 5 mg/cm² or less, 3 mg/cm² or less, or 1 mg/cm² or less. The basis weight “W₃” of the binder layer 22c may be, for example, 0.1 mg/cm² or more or 0.5 mg/cm² or more.

### Conductive Material

The conductive material may include, for example, acetylene black, carbon nanotube (CNT), vapor-grown carbon fiber (VGCF). The mass fraction of the conductive material may be substantially constant over the entire region of the active material layer. The mass fraction of the conductive material may be locally different. For example, the mass fraction of the conductive material may be different between the layers. For example, the type of the conductive material may be different between the layers. For example, the binder layer 22c may include a fibrous conductive material. The binder layer 22c may include, for example, at least one selected from the group consisting of CNT and VGCF. The fibrous conductive material may extend to crosslink the first active material layer 22a and the second active material layer 22b. By crosslinking the first active material layer 22a and the second active material layer 22b with the fibrous conductive material, for example, the improvement in the charge rate characteristics and the reduction of the interlayer peeling are expected.

What is claimed is:

1. A negative electrode for a non-aqueous electrolyte secondary battery, the negative electrode comprising:
a collector;
a first active material layer; and
a second active material layer, in an order of the collector, the first active material layer, and the second active material layer, wherein:
each of the first active material layer and the second active material layer contains a negative electrode active material;
the negative electrode active material contains artificial graphite and natural graphite;
a mass fraction of the artificial graphite in the first active material layer is higher than a mass fraction of the artificial graphite in the second active material layer;
a mass fraction of the natural graphite in the first active material layer is lower than a mass fraction of the natural graphite in the second active material layer;
an alignment angle of the negative electrode active material in the second active material layer is larger than an alignment angle of the negative electrode active material in the first active material layer; and
the alignment angle indicates an acute angle between a major axis diameter of the negative electrode active material and a surface of the collector.

2. The negative electrode according to claim 1, wherein:
each of the first active material layer and the second active material layer further contains a binder; and
a mass fraction of the binder in the first active material layer is lower than a mass fraction of the binder in the second active material layer.

3. The negative electrode according to claim 2, wherein:
the negative electrode includes the collector, the first active material layer, a binder layer, and the second active material layer in an order of the collector, the first active material layer, the binder layer, and the second active material layer; and
a mass fraction of the binder in the binder layer is higher than the mass fractions of the binder in the first active material layer and the second active material layer.

4. The negative electrode according to claim 1, wherein:
the negative electrode active material in the first active material layer has a bimodal particle size distribution; and
the negative electrode active material in the second active material layer has a monomodal particle size distribution.

5. A negative electrode for a non-aqueous electrolyte secondary battery, the negative electrode comprising:
a collector;
a first active material layer;
a binder layer; and
a second active material layer, in an order of the collector, the first active material layer, the binder layer, and the second active material layer, wherein:
each of the first active material layer and the second active material layer contains a negative electrode active material and a binder;
the negative electrode active material in the first active material layer has a bimodal particle size distribution;
the negative electrode active material in the second active material layer has a monomodal particle size distribution;
a mass fraction of the binder in the first active material layer is lower than a mass fraction of the binder in the second active material layer;
the negative electrode active material contains artificial graphite and natural graphite;
the natural graphite has a larger aspect ratio than the artificial graphite;
the negative electrode active material in the first active material layer substantially consists of the artificial graphite;
the negative electrode active material in the second active material layer substantially consists of the natural graphite;
an alignment angle of the negative electrode active material in the second active material layer is larger than an alignment angle of the negative electrode active material in the first active material layer;
the alignment angle indicates an acute angle between a major axis diameter of the negative electrode active material and a surface of the collector; and
a mass fraction of the binder in the binder layer is higher than the mass fractions of the binder in the first active material layer and the second active material layer.
